(19) United States
(12) Patent Application Publication
(10) Pub. No.: US 2022/0024465 A1
(43) Pub. Date: Jan. 27, 2022

(54) TRAILER SENSING AND REPORTING SYSTEM

(71) Applicants: Jonathan Padgett, Haines City, FL (US); Daniel Friddle, Haines City, FL (US)

(72) Inventors: Jonathan Padgett, Haines City, FL (US); Daniel Friddle, Haines City, FL (US)

(21) Appl. No.: 17/378,906

(22) Filed: Jul. 19, 2021

Related U.S. Application Data
(60) Provisional application No. 63/054,737, filed on Jul. 21, 2020.

(51) Int. Cl. B60W 40/13; G01F 23/296; B60W 40/076

(52) U.S. Cl. CPC B60W 40/13; G01F 23/296; B60W 40/076; B60W 2300/14; B60W 2756/10; B60W 2552/15; B60W 2555/40; B60W 2555/20; B60W 2420/54

(57) ABSTRACT

A trailer sensing and reporting system includes a primary sensing device and at least one secondary sensing device for securement onto a trailer or other enclosure having a material inside. Each of the sensing devices include a sensor suite for capturing trailer information including a level of material within the trailer, movement of the trailer and environmental conditions of the trailer. The primary sensing device includes a location module and a communication unit for sending a location of the trailer and trailer information captured by the sensor suites with at least one of a customer interface device, a trailer provider interface device or a system administration device.

### CROSS-REFERENCE TO RELATED APPLICATIONS

This application claims the benefit of U.S. Application Ser. No. 63/054,737 filed on Jul. 21, 2020, the contents of which are incorporated herein by reference.

### TECHNICAL FIELD

The present invention relates generally to commercial trailer systems, and more particularly to a trailer sensing and reporting system for determining an amount of material contained within a trailer and for reporting the location of the trailer itself.

### BACKGROUND

The statements in this section merely provide background information related to the present disclosure and may not constitute prior art.

Transportation of cargo via tractor-trailers is an important part of worldwide commerce. (In this context, a “tractor” is a reference to a highway truck, such as a semi-truck). To this end, it is not uncommon for trailers bearing certain types of cargo to be detached from the motor vehicle, and remain at a customer or other such location for a prolonged period of time.

For example, the commercial fertilizer industry utilizes specialty-built trailers having a plurality of separate bins which house fertilizer and other such substances. These trailers are typically transported to an end-user's location, where they remain parked until the contents are exhausted at which time the end user must call to have the trailer removed and replaced with another full trailer. In the past, end customers would have no way of determining how much material is remaining within their trailers at a given time, and likewise, the trailer owner would have no way of determining if the end user (or a third party) has moved or otherwise tampered with their trailer.

With these thoughts in mind, the inventors of the presently claimed invention have developed a novel system and method for allowing remote monitoring of a trailer, container, or other such housing in order to overcome the drawbacks described above.

### SUMMARY OF THE INVENTION

The present invention is directed to a trailer sensing and reporting system. One embodiment of the present invention can include a primary sensing device and at least one secondary sensing device for securement onto a trailer or other enclosure having a material inside. Each of the sensing devices can include a sensor suite for capturing trailer information such as the level of material within the trailer, movement of the trailer and environmental conditions within and about the trailer.

In one embodiment, each of the sensing devices can communicate locally, and the primary sensing device can include a communication unit for sending trailer information captured by the sensor suites with at least one customer interface device, a trailer provider interface device or a system administration device.

In one embodiment, the primary sensing device can include a location module for reporting a location of the trailer to which the device is secured to at least one of the customer interface device, the trailer provider interface device or the system administration device.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exemplary operating environment of a trailer sensing and reporting system that is useful for understanding the inventive concepts disclosed herein.

FIG. 2 is a perspective view of the trailer sensing and reporting system in operation, in accordance with one embodiment of the invention.

FIG. 3A is a perspective view of a primary sensing device of the trailer sensing and reporting system, in accordance with one embodiment of the invention.

FIG. 3B is a bottom view of a primary sensing device of the trailer sensing and reporting system, in accordance with one embodiment of the invention.

FIG. 4 is a simplified block diagram of a sensor suite within the primary sensing device of the trailer sensing and reporting system, in accordance with one embodiment of the invention.

FIG. 5 is a simplified block diagram of the primary controller within the primary sensing device of the trailer sensing and reporting system, in accordance with one embodiment of the invention.

FIG. 6 is a perspective view of a secondary sensing device of the trailer sensing and reporting system, in accordance with one embodiment of the invention.

FIG. 7 is a simplified block diagram of the controller within the secondary sensing device of the trailer sensing and reporting system, in accordance with one embodiment of the invention.

FIG. 8 is an exemplary presentation screen generated by the system environment of FIG. 1 of the trailer sensing and reporting system, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, the term “removably secured,” and derivatives thereof shall be used to describe a situation wherein two or more objects are joined together in a non-permanent manner so as to allow the same objects to be repeatedly joined and separated.

As described herein, the term “connector” includes any number of different elements that work alone or together to repeatedly join two items together in a nonpermanent manner. Several nonlimiting examples include opposing strips of hook and loop material (i.e., Velcro®), attractively-oriented magnetic elements, flexible strips of interlocking projections with a slider (i.e., zipper), a thin, flexible strap with a notched surface and one end threaded through a locking mechanism (i.e., zip tie) at the other, tethers, buckles such as side release buckles, and compression fittings such as T-handle rubber draw latches, hooks, snaps and buttons, for example. Each illustrated connector and complementary connector can be permanently secured to the illustrated portion of the device via a permanent sealer such as glue, adhesive tape, or stitching, for example.

As described herein, the term “system administrator” can be used to describe any individual, group or legal entity that is performing the below described system administration 130, in furtherance of the methodology described herein. In one embodiment, the system administrator can be the trailer provider, or can be a third-party company providing the below described methodology to the trailer provider and end user customer.

As described herein, a “trailer provider” can be any individual, group or legal entity that provides a trailer or other such container that is equipped with one or more of the below described primary or secondary sensing devices to an end user customer for any purpose.

As described herein, an “end user” and “customer” can be used interchangeably to describe any individual, group or legal entity that receives a trailer or other such container that is equipped with one or more of the below described primary or secondary sensing devices.

As described herein, “trailer information” shall include any data and other type of information that is captured by or derived from the below described trailer sensing system.

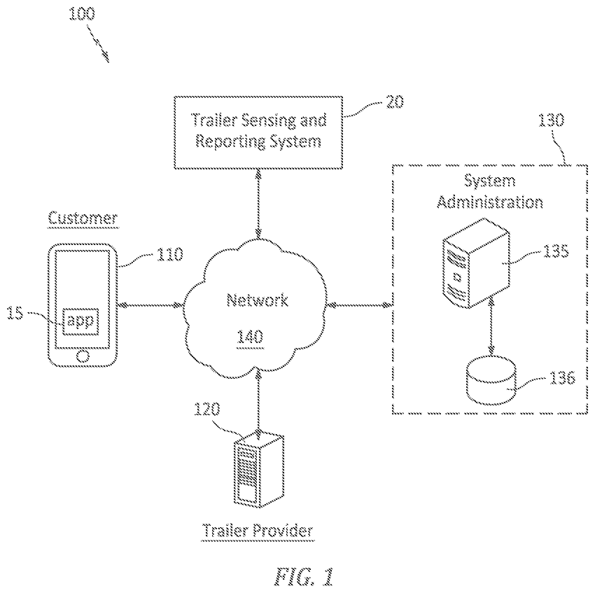

FIG. 1 is a schematic illustration of an exemplary operating environment 100 for utilizing the trailer reporting and sensing system. In one embodiment, the operating environment 100 can include a trailer reporting and sensing system 20 that can be in selective communication with a customer interface device 110, a trailer provider interface device 120, and a system administration device 130 over a network 140.

The network 140 can be any type of network, including a cellular network, a local area network (“LAN”), such as an intranet, a wide area network (“WAN”), the internet, and/or any other type of data transmission and reception medium, for example.

Each of the interface devices 110 and 120 can be any type of computing device that is operable by a human user. A computing device refers to any device with a processor and memory that can execute instructions and communicate with another device. Computing devices include, but are not limited to, computers, smartphones, tablet computers, smartwatches, laptop computers and/or purpose-built machines that are encoded with an application interface, so as to perform the functionality so described. In either instance, a computing device will include one or more client applications, such as a web browser, and/or an application interface, for example, which can allow the device to communicate with other interface devices and/or the system administration 130.

In one embodiment, the system can include a programming code for implementing the system functionality on a smartphone in the form of a mobile application (i.e., App) 15 which can be downloaded and installed onto the user device. As described herein, the mobile application 15 (i.e., trailer sensing and location application) can be any set of programmatic instructions that can be loaded onto any type of processor enabled device and can include program language for execution on the device that enables a user of the device to interact with the system 20 in order to receive trailer information and/or send operating instructions thereto.

The system administration 130, according to one embodiment, can include one or more individual computing devices 135 that can be connected to one or more databases 136 in which various portions of the below described methodology can be performed. In one embodiment, the system administration 130 can function to provide a central hub for controlling the communication between the interface devices 110 and 120 through any number of different mediums such as a website, a mobile application, or a direct connect audiovisual service such as cellular data, for example. In this regard, one or more of the individual computing devices 135 can include various web servers, email servers, application database servers and so forth.

The database 136 can function to store any type of data, including the system operating instructions for facilitating communication between the device components, routing information and/or generating presentation screens for implementing the below described methodology. To this end, the database can include any type of computer-readable storage mediums, including all forms of volatile and non-volatile memory.

In various embodiments, data captured by the trailer sensing and reporting system 20 can be stored on the database 136 and/or may be provided directly to the interface device(s) 110 and/or 120 for storage or viewing thereon.

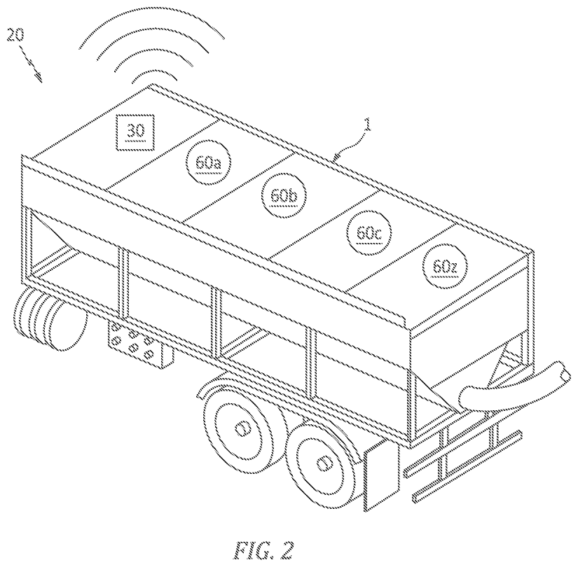

FIG. 2 illustrates one embodiment of a trailer sensing and reporting system 20. As shown, the system 20 can be positioned along any type of trailer 1 and can include a primary sensing device 30, and any number of secondary sensing devices 60a-60z (referred to collectively below as 60).

Although illustrated in the drawings with regard to a multi-compartmented trailer for receiving and discharging fertilizer, this is for illustrative purposes only. To this end, the “trailer” can include, comprise, or consist of any type of moveable structure capable of receiving and storing any type of material and/or capable of being towed by a motor vehicle. Of course, other embodiments are contemplated wherein the system functionality can be imparted onto other types of trailers and/or motor vehicles themselves, for example.

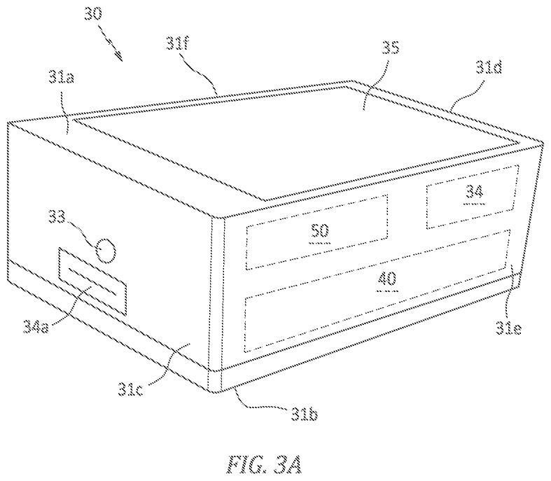

As shown at FIGS. 3A and 3B, one embodiment of the primary sensing device 30 can include an outer shell/main body, having a visual display unit, a power source, a sensor suite, and a controller.

In the illustrated embodiment, the main body can include a generally rectangular-shaped member having a top surface 31a, a bottom surface 31b, and a plurality of side surfaces 31c, 31d, 31e and 31f that form a watertight inside space for receiving and storing the device components. The main body can be constructed from any number of different materials that are, for example, relatively strong and stiff for their weight. Several nonlimiting examples include but are not limited to various lightweight metals or metal alloys (e.g., aluminum, or alloys thereof), or plastic/polymers (e.g., high-density polyethylene (HDPE), rigid polyvinyl chloride (PVC), or polyethylene terephthalate (PET)), for example. Of course, any number of other shapes, sizes and construction materials are also contemplated.

In one embodiment, a plurality of apertures 32 can be disposed along the bottom surface 31b of main body so as to receive a screw (not illustrated) for securing the device 30 onto the trailer. As noted below, the main body will preferably be mounted along the top of the trailer, so as to orient the material sensor toward the top surface of the fertilizer (or other material) stored within the trailer compartment. Of course, this is but one possible way of mounting the device onto a trailer, as any number of different types of connectors may be utilized to secure the device onto any portion of a trailer in a removable or permanent manner.

The display unit 33 can include virtually any type of device capable of providing a visual notification to a user. Several nonlimiting examples include one or more lights such as LED's, for example, an LCD display, and/or a Graphic User Interface (GUI) capable of performing two way communication with a device user. The display unit can be communicatively linked to the below described controller and sensor suite and can preferably function to provide a visual notification (e.g., blinking light) when the sensor suite determines that the amount of material stored within the trailer compartment is exhausted, low or beneath a given threshold (e.g., less than 50%).

The power source 34 can include one or more batteries capable of providing the necessary power requirements to each element of the device 30. In the preferred embodiment, the batteries can be permanently located within the main body and can be rechargeable in nature via a charging port 34a, such as a mini or micro-USB port, for example. Of course, traditional batteries can also be utilized, and the main body can further include a battery compartment having a removable cover (not illustrated) for allowing a user to access the same.

In one embodiment, a solar panel 35 having any number of photovoltaic cells can be positioned along the main body and can be electrically connected to the power source 34. The solar panel functioning to maintain the battery at a charge level suitable for continued operation of the device in the manner described herein.

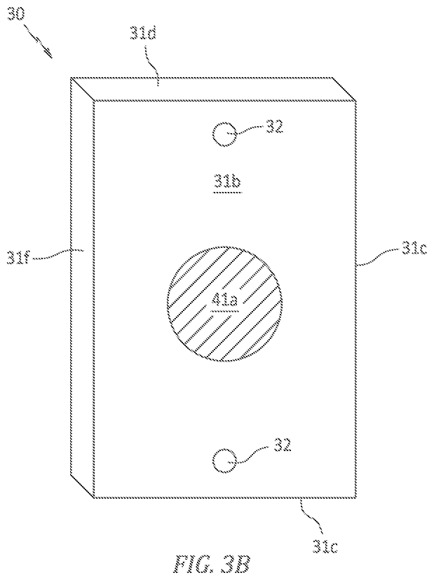

The primary sensing device 30 and each of the below described secondary sensing devices 60 can include any number of individual sensors, and/or sensor assemblies referred to collectively as a sensor suite 40 for capturing trailer information. As shown at FIG. 4, one embodiment of a sensor suite 40 for use herein can include a material sensor 41, a movement sensor 42, an elevation sensor 43, and/or a temperature sensor 44.

The material sensor 41 can include any number of components capable of determining the presence and/or amount of material/cargo stored within the trailer or trailer compartment to which the device 30 is secured. In one embodiment, the material sensor can include an ultrasonic sonar sensor having an emitter 41a that is positioned along the bottom of the main body 31b.

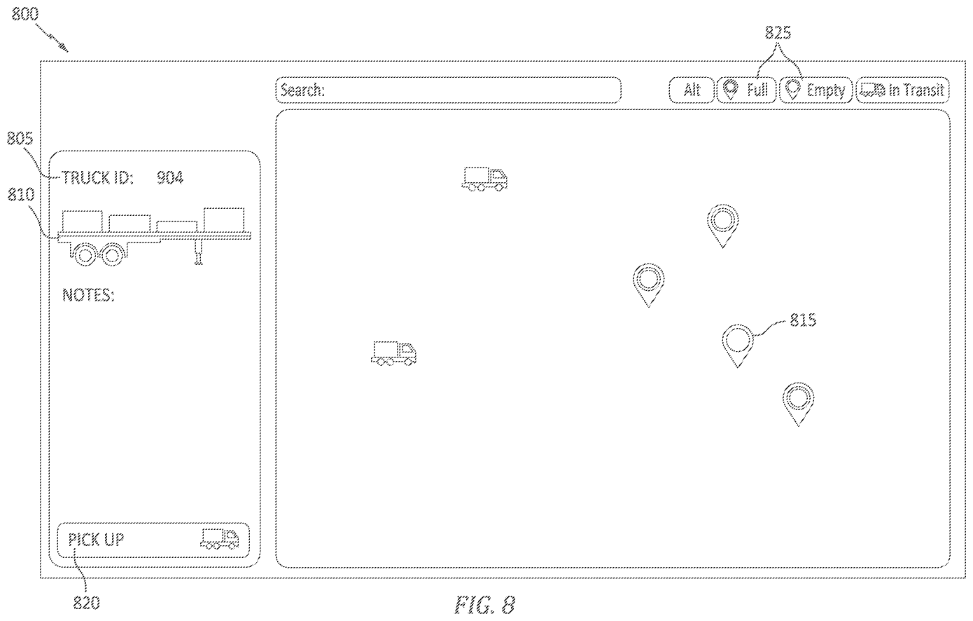

The emitter can function to emit sound waves through an opening that is cut or otherwise provided on the top surface of the trailer 1, so as to allow the waves to impact the top of the material (e.g., fertilizer) stored within the trailer. As the volume of material within the trailer is reduced, the top surface of the material will gradually be lowered, and the time signal returns will increase, thus allowing the processor to determine how full the compartment is at any given time (See FIG. 8).

Of course, the material sensor is not limited to the use of a sonar sensor, as any number of other devices capable of detecting the presence of material within the trailer and reporting a change in the level/volume or amount of the same are also contemplated.

The movement sensor 42 can function to detect a movement of the trailer or trailer compartment to which the device 30 is secured. To this end, the movement sensor can include any number of components such as an accelerometer, tilt switch, level switch and the like, for example capable of detecting vibrations, speed and other forms of trailer movement.

The Environment sensor 43 can function to detect and report environmental details pertaining to the outside and inside of the trailer. For example, the sensor 43 can function to determine the altitude, barometric pressure, temperature, and humidity. Such features being beneficial for allowing the trailer provider and customer to ensure the conditions for using the fertilizer/materials stored within the trailer fall within the acceptable ranges, as some types of fertilizer are not recommended for use in certain conditions or at certain temperatures.

Although not specifically illustrated, some embodiments are contemplated wherein audiovisual sensors such as a camera, speaker or microphone can be provided along or within the main body to capture audiovisual information. This information can be oriented toward the trailer environment to help identify the location of the trailer if stolen or directed toward the inside of the trailer to physically inspect the trailer material/cargo, for example. This information can form part of the “trailer information” and can be shared with the interface devices described above in the same manner.

The sensor suite 40 can be coupled to the below described control unit 50, so as to receive operating instructions and to allow the trailer information to be stored and transmitted to an external device such as the customer interface device 110, the trailer provider interface 120 and/or the system administration 130 in real time. Although described above as including specific components 41-43, this is for illustrative purposes only, as those of skill in the art will recognize that any number of additional sensors/components can be provided in order to capture any other types of trailer information.

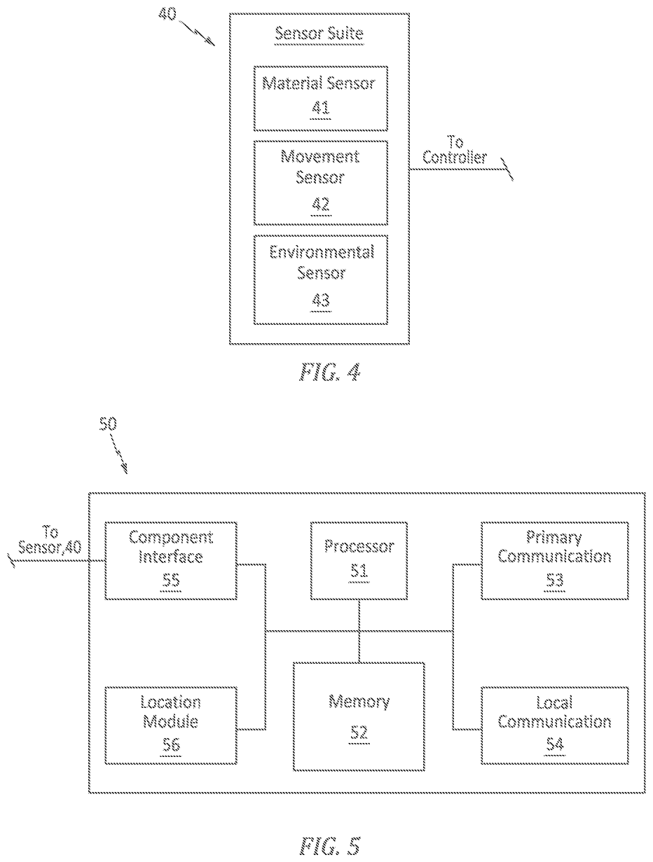

FIG. 5 is a simplistic block diagram illustrating one embodiment of the primary device controller 50, which can control an operation of the sensor suite 40 within the primary sensing device 30, in order to store and/or transmit the captured trailer information to the customer interface device 110, the trailer provider interface 120 and/or the system administration 130. Additionally, the primary device controller 50 can be communicatively linked to each of the secondary sensor devices 60 described below in order to store and report trailer information captured by these units in the same manner.

As shown, the primary controller 50 can include a processing unit 51 that is conventionally connected to an internal memory 52, a primary communication unit 53, a local communication unit 54, a component interface unit 55, and a location determination unit 56.

Although illustrated as separate elements, those of skill in the art will recognize that one or more system components 41-43 and/or 51-56 may comprise or include one or more printed circuit boards (PCB) containing any number of integrated circuit or circuits for completing the activities described herein. The CPU may be one or more integrated circuits having firmware for causing the circuitry to complete the activities described herein. Of course, any number of other analog and/or digital components capable of performing the described functionality can be provided in place of, or in conjunction with the described elements.

The processor 51 can include one or more central processing units (CPU) or any other type of device, or multiple devices, capable of manipulating or processing information such as program code stored in the memory 52 in order to allow the device to perform the functionality described herein.

Memory 52 can act to store operating instructions in the form of program code for the processor 51 to execute. Although illustrated in FIG. 5 as a single component, memory 52 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device such as a solid-state hard drive, for example.

The primary communication unit 53 can include any number of discrete or integrated components capable of sending and/or receiving electronic signals with another device. In one preferred embodiment, the primary communication unit 53 can include a cellular transceiver for communicating wirelessly with a remotely located user interface device such as the customer interface device 110, the trailer provider interface 120 and/or the system administration 130, either directly or over a network.

Of course, the primary communication unit is not limited to the use of a cellular transceiver, as any number of other transmission and reception mechanisms and protocols can also be utilized herein.

The local communication unit 54 can include any number of discrete or integrated components capable of sending and/or receiving electronic signals with another device. In one embodiment, the local communication unit 54 can include a radio transceiver for communicating wirelessly with one or more of the secondary sensing devices 60 described below.

Of course, the local communication unit is not limited to the use of radio communication, as any number of other transmission and reception mechanisms and protocols can also be utilized herein. Several nonlimiting examples include Bluetooth, WiFi, cellular transceivers, and/or Near-Field-Communication (NFC) devices, for example. Likewise, communication between the primary and secondary sensing devices can also be performed via one or more hard wired connections, which can utilize the above-described USB port 34a, for example.

The component interface unit 55 can function to provide a communicative link between the processing unit 51 and various system elements such as the primary sensor suite 40 and each of the secondary sensing devices 60. In this regard, the component interface unit can include any number of different components such as one or more PIC microcontrollers, bus cables, and/or cable connectors (e.g., com port, USB port), among other types of known communication hardware capable of engaging any number of communication cables in order to link the controller 50 to each of the secondary sensing devices 60.

Although described or illustrated with regard to external plugs for engaging cables, other embodiments are contemplated wherein the cables are hard wired between the primary sensing device 30 and one or more of the secondary sensing devices 60.

The location identification module 56 can function to provide real time location information (e.g., address, GPS coordinates, etc.) of the trailer 1 to which the system is attached. In one embodiment, the location module can comprise a discrete GPS signal antenna, and transceiver for communicating with a third-party location tracking company that provides tracking and/or retrieval services for registered GPS enabled devices. Such a feature allows the trailer provider to know the exact location of their trailers at all times, along with receiving a notification if/when the trailer is moved.

Alternatively, or as a backup to the GPS, the location module 56 can utilize the cellular transceiver of the primary communication unit to interact with the mapping and location services offered by the cellular provider, as is known in the art. In either instance, the captured location information can be determined, stored by the system memory and available to system users at any time.

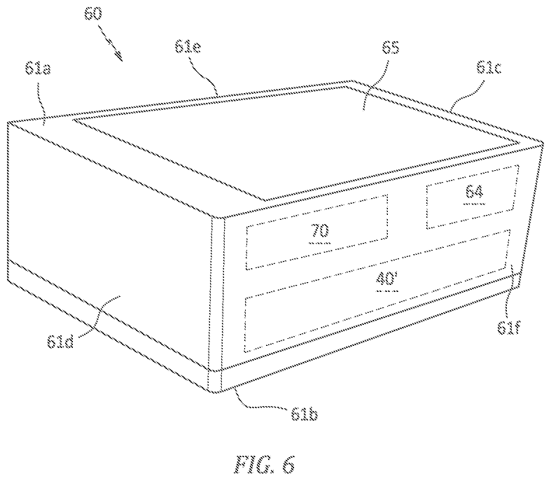

FIG. 6 illustrates one embodiment of a secondary sensor unit 60 that can be communicatively linked to the primary sensor unit 30 described above. As shown, the secondary sensor unit can include a main body having a top surface 61a, a bottom surface 61b and a plurality of side surfaces 61c, 61d, 61e and 61f that form a watertight inside space for receiving and storing the device components.

In one embodiment, the secondary sensor unit 60 will include an identical shape, size, and construction material as the primary sensor unit, along with the same mounting and sensor configuration. Of course, other embodiments are contemplated.

In one embodiment, the secondary sensor unit can include a power source 64, a solar panel 65, a sensor suite 40′ and a controller 70. As described herein, elements 64, 65 and 40′ can be identical or otherwise include the same components and/or functionality as elements 34, 35, and 40, respectively, described above therefore a duplicate description will not be provided.

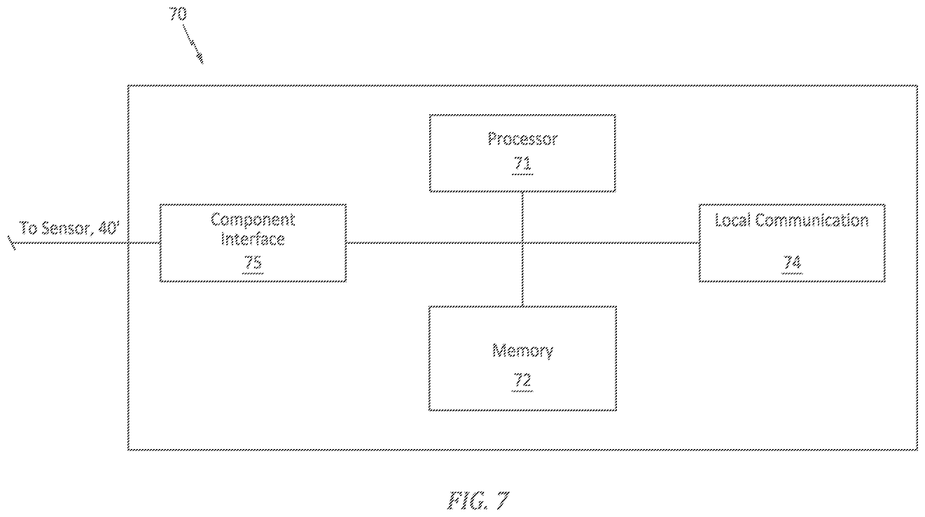

FIG. 7 is a simplistic block diagram illustrating one embodiment of the secondary device controller 70, which can control an operation of the sensor suite 40′ within the secondary sensing device 60, in order to store and/or transmit the captured trailer information to the primary sensing device 30.

As shown, the controller 70 can include a processing unit 71 that is conventionally connected to an internal memory 72, a local communication unit 74, and a component interface unit 75. As described herein, elements 71, 72, 74, and 75 can be identical or otherwise include the same components and/or functionality as elements 51, 52, 54, and 55, respectively, described above therefore a duplicate description will not be provided.

In operation, once the system 20 is secured onto a trailer 1 as shown and described above, the sensor suites 40 and 40′ can begin to collect trailer information. This information along with the trailer location can be sent to the system environment 100 for viewing by one or more of the customer interface device 110, trailer provider interface device 120, and/or system administration 130.

In one nonlimiting example shown at FIG. 8, the system can generate an exemplary presentation screen 800 which can display the trailer information captured by the system 20. As shown, this information can include a trailer identification 805, a graphic showing the current amount of material within each compartment 810 of the trailer, and a map showing the location 815 of the trailer and others associated with the user account. The screen can also provide options for requesting a pickup/replacement of the trailer 820 along with the ability to show trailers based on their current fill levels 825. Of course, many other options are also contemplated.

As noted above, the inventive system permits both a trailer provider and end user to have accurate information about the status of material within a trailer or other such enclosure so as to monitor usage and ensure timely reordering of the same.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A trailer sensing and reporting system, comprising:
a primary sensing device having a main body and a connector for engaging a trailer;
a communication unit that is positioned within the primary sensing device; and
a sensor suite that is positioned within the primary sensing device,
wherein the communication unit includes functionality for communicating trailer information with at least one of a customer interface device, a trailer provider interface device or a system administration device.

2. The system of claim 1, wherein the sensor suite includes a material sensor that is configured to determine a level of material located within the trailer to which the primary sensing device is secured.

3. The system of claim 2, wherein the material sensor comprises an ultrasonic sensor.

4. The system of claim 1, wherein the sensor suite includes a movement sensor that is configured to detect a movement of the trailer to which the primary sensing device is secured.

5. The system of claim 4, wherein said movement includes an acceleration movement, a tilting movement, and a vibration movement.

6. The system of claim 1, wherein the sensor suite includes an environmental sensor that is configured to detect environmental conditions within an inside portion of the trailer and environmental conditions along an outside surface of the trailer.

7. The system of claim 6, wherein said environmental conditions include altitude, barometric pressure, temperature, and humidity.

8. The system of claim 1, further comprising:
a trailer sensing and reporting application, said application comprising machine readable instructions for execution on a computing device having a processor, a memory, and a display screen,
wherein the application includes functionality for communicating with the primary sensing device to receive trailer information captured by the primary sensor suite.

9. The system of claim 1, further comprising:
at least one secondary sensing device, each of the at least one secondary sensing device including a main body and a connector for engaging the trailer, and a secondary sensor suite that is positioned within the secondary sensing device.

10. The system of claim 9, wherein each of the at least one secondary sensing device includes functionality for communicating trailer information with the primary sensing device.

11. The system of claim 10, wherein the secondary sensor suite includes a material sensor that is configured to determine a level of material located within the trailer to which the secondary sensing device is secured.

12. The system of claim 11, wherein the material sensor comprises an ultrasonic sensor.

13. The system of claim 9, wherein the secondary sensor suite includes a movement sensor that is configured to detect a movement of the trailer to which the secondary sensing device is secured.

14. The system of claim 13, wherein said movement includes an acceleration movement, a tilting movement, and a vibration movement.

15. The system of claim 9, wherein the secondary sensor suite includes an environmental sensor that is configured to detect environmental conditions within an inside portion of the trailer and environmental conditions along an outside surface of the trailer.

16. The system of claim 15, wherein said environmental conditions include altitude, barometric pressure, temperature, and humidity.

17. The system of claim 1, further comprising:
a trailer sensing and reporting application, said application comprising machine readable instructions for execution on a computing device having a processor, a memory, and a display screen,
wherein the application includes functionality for communicating with the primary sensing device to receive trailer information captured by the primary sensor suite and each of the at least one secondary sensing device.
